(19) United States
(12) Patent Application Publication
(10) Pub. No.: US 2023/0410050 A1
(43) Pub. Date: Dec. 21, 2023

(54) INTERACTIVE GRAPHICAL USER INTERFACE FOR PRODUCING CUSTOM INJECTION MOLDED PARTS

(71) Applicant: Evok LLC, (US)

(72) Inventor: Paul Dathe, Plymouth, MN (US)

(21) Appl. No.: 18/212,600

(22) Filed: Jun. 21, 2023

Related U.S. Application Data
(60) Provisional application No. 63/354,151, filed on Jun. 21, 2022.

(51) Int. Cl. G06Q 10/10; G06Q 10/0637; B29C 45/76

(52) U.S. Cl. CPC G06Q 10/103; G06Q 10/06375; B29C 45/766; B29C 2945/76943

(57) ABSTRACT

A user-friendly system for analyzing and visualizing the production of injection molding parts in real-time is described in these papers. By utilizing a unique algorithm and interface, it instantly estimates manufacturing costs and timelines based on user inputs like part design and material choice. An interactive dashboard displays this critical information, fostering team collaboration and efficient decision-making. Changes to variables automatically update the calculations, promoting transparency, reducing waste and enhancing cost-effectiveness in the manufacturing process.

### CROSS-REFERENCE TO RELATED APPLICATIONS

This application claims the benefit of, and priority to, U.S. Provisional Patent Application No. 63/354,151 filed Jun. 21, 2022, titled “SYSTEMS AND METHODS FOR REAL-TIME, INTERACTIVE PRODUCTION ANALYSIS FOR CUSTOM INJECTION MOLDED PARTS.” That application is incorporated by reference herein in its entirety.

### BACKGROUND

### Field of the Art

The present disclosure relates a user interface for providing a real-time, interactive production planning and analysis experience for custom injection molded parts.

### Discussion of the State of the Art

The discussion below is provided for general background information and is not intended to be used as an aid in determining the scope of the claimed subject matter.

Current approaches to new product development technologies related to part design, mold design and plastic injection processing generally lack business to business collaboration tools that can facilitate accurate time and cost estimates based on a customer's specific needs and their own circumstantial change. Existing tools generally lack transparency in cycle time and material cost detail, often creating a lack of trust between product designers, purchasing agents, and business leadership decision makers. Moreover, current approaches require substantial calculation time and are prone to errors commonly exhibited between part development, quoting and part purchasing activities. There is a need for a customized, confidential, internal business collaboration tool that develops accurate predictions, higher confidence and real time feedback related to part geometry, material, and mold options during product design and investment decisions.

Obtaining a supplier price quote for an injection molded part is a very complicated and time-consuming task for engineers, purchasing agents and supply manufactures looking to develop an optimized financial business model. Such quotes typically include part cost, mold cost, and lead time. Changes to the part design, mold design and material, introduce a host of financial and processing ramifications that have traditionally been calculated only by a downstream vendor or service provider with enough knowledge to quote. Typical lead times for custom injection molded part quotes can range from 1 day and up to 2-3 weeks. During the waiting period, the product development team is in question, confidence in part price and project success is “on hold” and teams are paralyzed, and new product introductions are held hostage ultimately wrinkling the momentum of a new idea, product, or cost savings initiative.

In injection molding, factors such as clamp force requirement, cavitation, part geometry, cost of material, specific gravity material type or consumption of parts can change the mold and part cost dramatically. While the effects of one combination of these factors may be realized by one user, they may not be realized by another user on the same team depending on each user's knowledge of the contributing weight of each input factor on the production processes and production optimization. Changing these variables can take weeks during the new product development cycle and can be associated with a sticker shock factor when the part quotes finally come in from manufacturers. Under current approaches, understanding the effects of these changes becomes painful as designers and purchasing agents wait for pricing updates based on the changes. If the impacts of these changes can be realized in near real time, developers can easily change the trajectory of a proposed new product introduction.

### SUMMARY

The present invention addresses the above issues by providing a customized trust-based tool with transparency regarding manufacturing costs and eliminates painful time delays and uncertainties during the formal mold and part quoting processes. More specifically, the present disclosure relates to a configurable injection molding part production analysis and display system providing instant and accurate estimations of manufacturing time and cost data with respect to user changes in part design, material selection and production lifetime and quantity expectations. The inventive concepts disclosed herein eliminate or reduce the disconnect between engineers and purchasing agents by providing an instant, accurate definition of expected part price and processing with consideration of a vast, constantly changing spectrum of variables. Furthermore, the inventive concepts disclosed herein allow for real-time decision making as part of the design process that can significantly reduce waste associated with materials, time and energy, and ultimately reduce cost.

One exemplary embodiment provides a live interactive dashboard configured to display all critical processing information necessary for a business to make decisions regarding part design. This dashboard provides the ability for live, real-time collaboration between team members associated with a particular part design and development project so that the impacts of changing a variable associated with part design and manufacturing can be recognized by all team members in real-time. The unique user interface disclosed herein coupled with a proprietary algorithm for estimating part production aspects, such as cost breakdown and production time, provide the ability to generate the live interactive dashboard discussed above.

An exemplary process associated with the inventive concerts herein comprise receiving, from a user, part information, such as dimensions, material, production quantity and anticipated part lifetime, computing estimated production time and costs as well as identifying optimal manufacturing characteristics, such as number of mold cavities to use, and provides this information in real-time upon receiving the information from the user. The disclosed inventive concepts further allow for real-time updates of both computing and displaying the estimated production time and costs whenever a user changes a variable that affects these computations. In this way, users are provided with real-time, interactive feedback regarding the impacts of different design choices associated with creating an injection molded part.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for real-time, interactive production analysis in accordance with an exemplary embodiment of the invention.

FIG. 2A illustrates a system for providing real-time, interactive production analysis in accordance with an exemplary embodiment of the present invention.

FIG. 2B illustrates a first exemplary user interface that may be generated and used in accordance with an embodiment of the invention

FIG. 2C illustrates a second exemplary user interface that may be generated in accordance with an embodiment of the invention.

FIG. 3 illustrates an exemplary process for providing real-time, interactive custom part production analysis according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

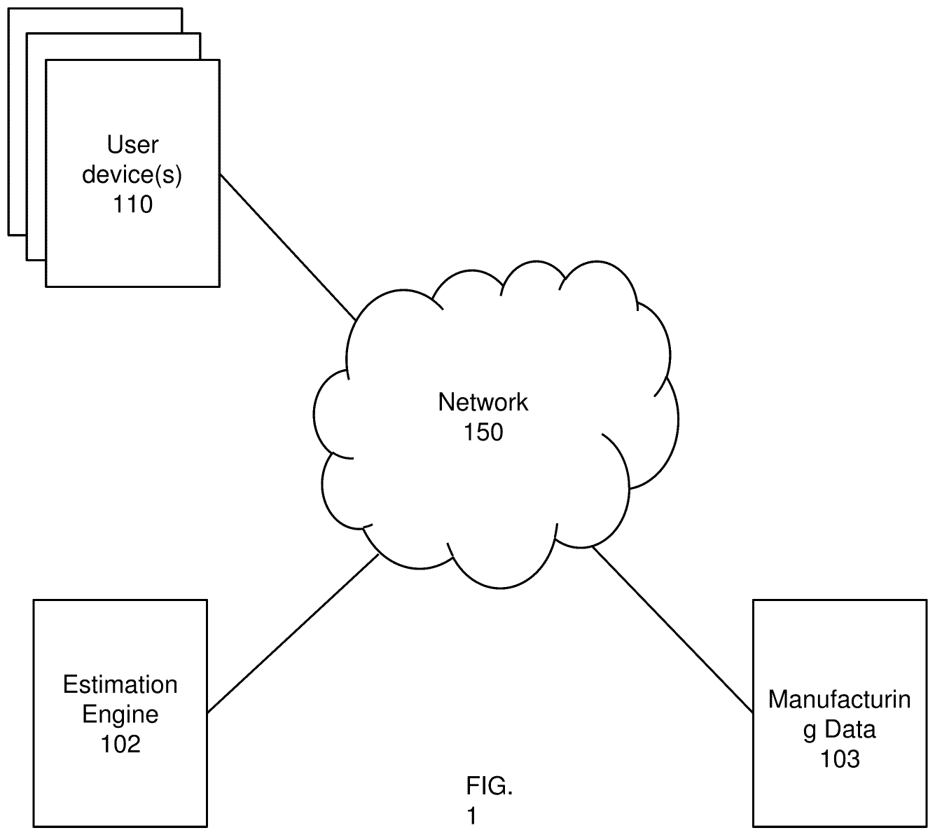

FIG. 1 illustrates an exemplary embodiment of a system for real-time, interactive production analysis for custom injection molded parts according to one embodiment. The system comprises user device(s) 110, estimation engine 102, manufacturing data 103, and a network 150 over which the various systems communicate and interact. The various computing devices described herein are exemplary and for illustration purposes only. The system may be reorganized or consolidated, as understood by a person of ordinary skill in the art, to perform the same tasks on one or more other servers or computing devices without departing from the scope of the invention.

Estimation engine 102 generally comprises hardware and/or software configured to obtain at least one of user input data associated with a part to be injection molded and manufacturing data 103, and compute production analytics using the user input data and manufacturing data. In one aspect, estimation engine 102 obtains part data such as part dimensions and material to be used in making the part, anticipated part lifetime and number of parts to be made via injection molding. Based on the obtained data, estimation engine 102 computes data associated with part production including, but not limited to, tooling cost, estimated production and delivery time, materials cost, labor cost, and the cost breakdown associated with using different mold cavity quantities in the manufacturing process. Estimation engine 102 also generates and updates user interfaces and information to be displayed, in real-time as part production data is computed.

Manufacturing data 103 generally comprises manufacturing information associated with injection molding manufacturing techniques and processes. Manufacturing data 103 may comprise general engineering and thermodynamics information associated with injection molding. Manufacturing data may comprise data from material suppliers such as custom data associated with supplier materials. Manufacturing data may comprise data from injection molders such as manufacturing capabilities, mold types, current manufacturing capacity, availability and types of molding machines, manufacturing costs/rates, etc. Although depicted as a separate element, manufacturing data 103 may be incorporated into estimation engine 102, such as in a database or datastore component of the estimation engine 102.

User device(s) 110 generally comprise any computing device for providing data associated with a part to be manufactured via injection molding and receiving production analysis data computed based on the provided data and manufacturing data. User device(s) 110 may comprise a display component or otherwise communicate received production analysis data to an associate display for viewing by a user.

User device(s) 110 include, generally, a computer or computing device including functionality for communicating (e.g., remotely) over a network 150. Data may be collected from user devices 110, and data requests may be initiated from each user device 110. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. user devices 110 may execute one or more user applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device 110 may be an electronic device including hardware, software, or embedded logic components or a combination of two or more such components and capable of carrying out the appropriate functions implemented or supported by the user device 110. For example and without limitation, a user device 110 may be a desktop computer system, a notebook computer system, a netbook computer system, a handheld electronic device, or a mobile telephone. The present disclosure contemplates any user device 110. A user device 110 may enable a network user at the user device 110 to access network 150. A user device 110 may enable its user to communicate with other users at other user devices 110.

A user device 110 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device 110 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to user devices or other devices in response to HTTP or other requests from user devices or other devices. A mail server is generally capable of providing electronic mail services to various user devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

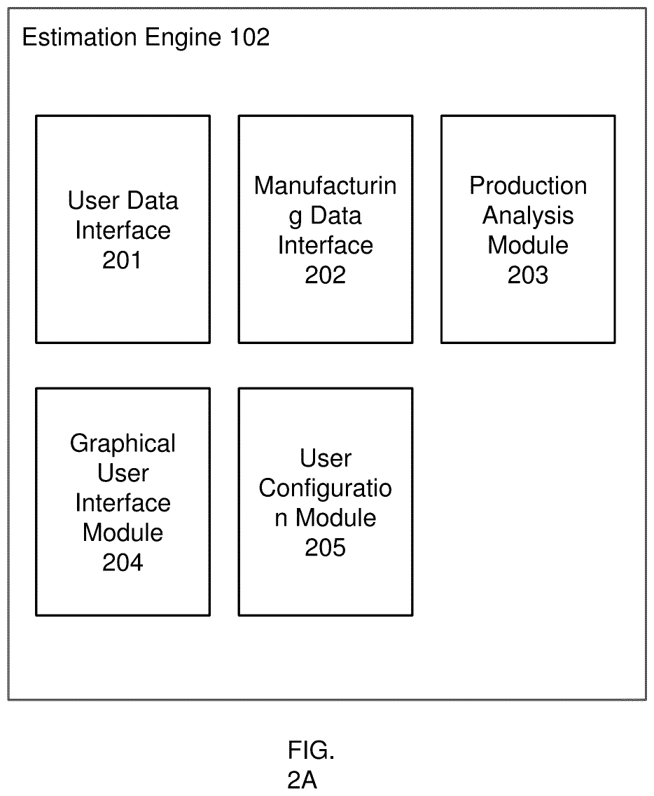

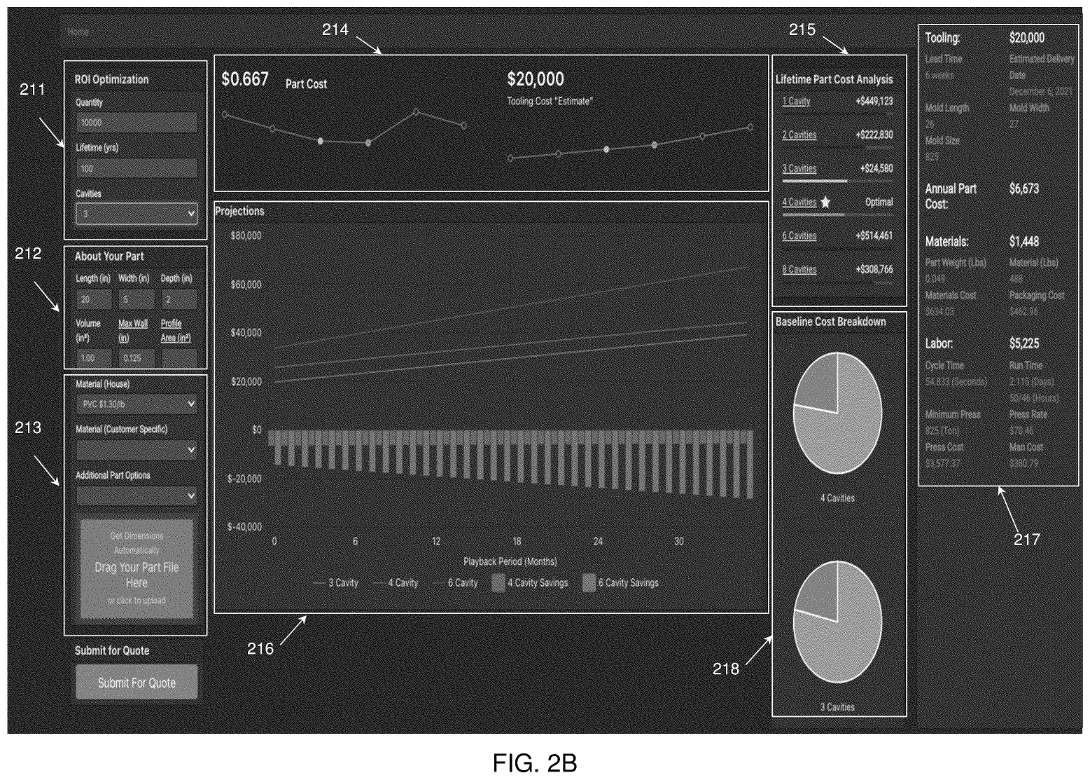

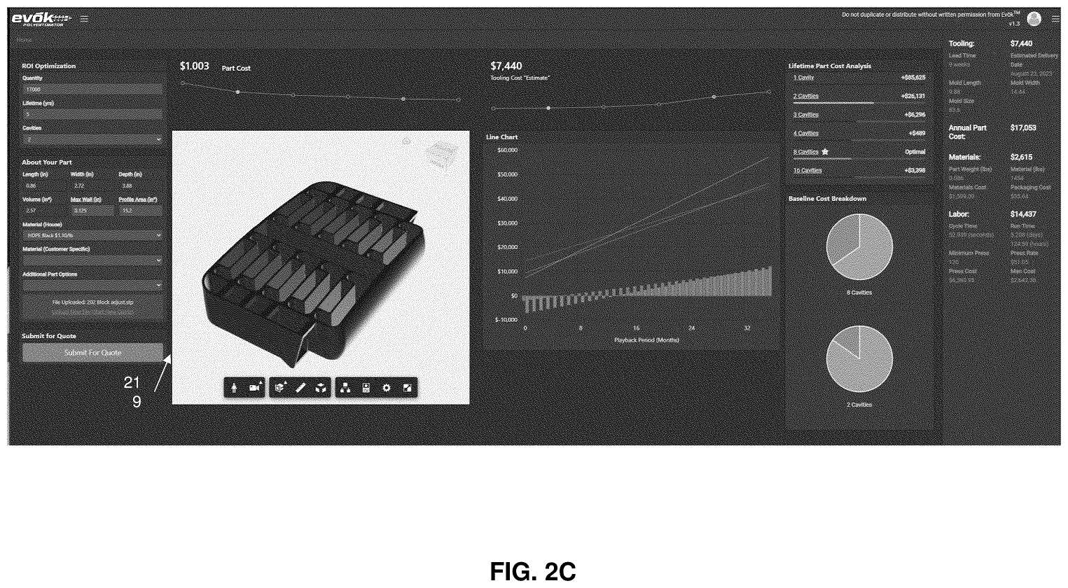

FIG. 2A illustrates an exemplary embodiment of the estimation engine 102 according to an exemplary embodiment of the invention. The estimation engine 102 comprises user data interface 201, manufacturing data interface 202, production analysis module 203, graphical user interface (GUI) module 204, and user configuration module 205.

User data interface 201 obtains user input data associated with a part a user has or is designing to be manufactured by injection molding. User data obtained via this interface comprises at least one of part dimensions such as length, width, and depth, part volume, maximum wall thickness, part profile area, annual quantity of parts to be produced, expected part lifetime, anticipated number of cavities for the mold, the material the part is to be made from, and any additional part options such as color, texture and additives.

Manufacturing data interface 202 obtains manufacturing data associated with injection molding processes. Manufacturing data may be obtained from a database which is either incorporated into estimation engine 102 or external to estimation engine 102 such as depicted in FIG. 1. Alternatively, manufacturing data may be obtained via user input such as user entry of manufacturer or part specific injection molding factors. Manufacturing data may comprise thermodynamic principles associated with injection molding processes. Manufacturing data interface 202 may be configured to obtain material science data from manufacturers as additional material data becomes available which affect injection molding processes such that the estimation engine 102 is enabled to use this up to date material science data to more accurately compute production analysis data (which is discussed in more detail below).

Production analysis module 203 computes production analysis data using user input data and manufacturing data. Production analysis data comprises at least one of tooling data, annual part cost data, and lifetime part cost data. Tooling data comprises at least one of tooling cost, lead time, estimated delivery date, part geometry, part volume, specific gravity of identified material for the part, mold length, mold width and mold size. Annual part cost data comprises both material cost data and labor cost data. Material cost data comprises at least one of part weight, weight of material needed to make the part(s) as specified by the user input, material cost to make the part(s) as specified by the user input, and packaging cost. Labor cost data comprises at least one of cycle time, run time, press rate, minimum press tonnage requirement, press cost, and manual labor cost associated with manufacturing of the part. Lifetime part cost analysis data comprises data associated with cost projections over time, a breakdown of cost savings or additional expenses associated with a plurality of different injection molding cavity options (e.g. 1, 2, 3, 4, 6, 8, etc. cavities), a breakdown of the material and labor costs associated with each of the cavity options, and an identification of the optimal number of cavities to use in part production.

Production analysis module 203 may comprise a tooling wizard configured to estimate costs associated with a variety of tooling operations. The tooling wizard may estimate tooling based on part quantities obtained via user data interface 201. Tooling wizard may apply thresholds associated with part quantities in order to determine tooling options as part of the tooling cost estimation. For example, if part quantities are below a first threshold amount, tooling wizard may recommend low cost, short lifespan tooling options such as quick turn aluminum without cooling, in order to reduce tooling costs and estimate tooling costs accordingly. If part quantities are above the first threshold, but below a second threshold, tooling wizard may recommend mudset in aluminum molds as the tooling operation and estimate tooling costs accordingly. When part quantities are above the second threshold, but below a third threshold, tooling wizard may recommend more durable molds such as P20 steel molds and estimate tooling costs accordingly. When part quantities exceed the third threshold, tooling wizard may recommend higher cost, longer lasting mold options such as H13 hardened steel dedicated three plate molds.

Tooling wizard may be implemented as a backend process and simply output the recommendation and cost results. Tooling wizard may be an interactive tool which, in combination with graphical user interface module 204, provides an interactive dashboard where users can see tooling recommendations and costs in real time and immediately see the effects of changing user input on tooling costs and recommendations. Furthermore, tooling wizard may provide an interactive dashboard showing, in real time, how user input variables such as part length and width, affect mold layout and mold size which in turn affects press requirements since a mold must fit within the tie bar spacing of the press. Although described herein as part of the production analysis module 203, the tooling wizard may be a separate module of the estimation engine 102 or a module separate from the estimation engine 102. FIG. 2B below depicts exemplary mold size and layout configurations based on part length and width. Tool wizard may display this information in a similar format or another format along with the effects of these different scenarios on press requirements and associated cost.

Tooling wizard may also consider other various tooling options as part of the tooling estimation. For example, if a manufacturer cannot reintroduce a collateral runner system, the tooling wizard considers a HOT runner system as an optional alternative in estimating production cost. Another tooling option considered by the tooling wizard comprises use of a specific mold material, which may be based on the selected part material, such as when a particular mold material is needed to combat chemical erosion and off-gassing.

Production analysis module 203 may be configured to obtain live stream data or real-time information associated with a variety of production variables. In one aspect, the live stream data or real-time information may be obtained via manufacturing data interface 202. The live stream of data or real-time information may comprise market prices associated with materials and may be obtained from different material manufacturers, suppliers, or other material cost data sources. The live stream of data or real-time information may comprise press information associated with at least one manufacturer. For example, live stream data or real-time information may indicate current or future expected availability of manufacturer presses, capacity at which presses are operating (e.g. such as a percentage of their max capability), and current or future expected cost associated with manufacturer presses (e.g. press costs may change based on demand or availability associated with each press or based on manufacturer defined pricing). The production analysis module 203 is configured to use this real-time information in computing production data such as production cost and production time frame. Although described herein in association with the production analysis module 203, this live data feed aspect may be incorporated into a separate module of the estimation engine 102 which is in communication with the production analysis module 203.

Graphical user interface (GUI) module 204 generates and provides user interfaces and updates the information to be displayed in accordance with various aspects of the disclosed invention. For example, GUI module 204 is configured to generate an initial user interface comprising at least a first user interface element for obtaining user input data. GUI module 204 is configured to generate and update a second user interface element to display output data such as computed production analysis data based on user input data obtained via the first user interface element. Exemplary user interfaces that can be generated by the GUI module 204 are shown in FIGS. 2B-2C. GUI module 204 may generate interfaces for tooling wizard as discussed above. GUI module 204 may generate a material selection wizard interface. As an alternative or in addition to the first user interface element 210 which is discussed below and used to obtain user input associated with at least a material selection or identification, a material selection wizard interface may be generated to assist users with selecting an appropriate material for their part. The material selection wizard interface may be a separate interface, such as a pop out window or integrated into the first user interface element 210 below. The material selection wizard interface comprises an element for obtaining or receiving selection of at least one material property including but not limited to material flexibility/rigidity, outdoor vs. indoor use, tensile strength, impact strength, elongation capability (e.g. percentage elongation), water absorption capability, and clarity (e.g. opaque, translucent, transparent). The material selection wizard interface may comprise one or more sliders for adjusting the above mentioned material properties. The material selection wizard interface may comprise one or more text or numeric entry fields for obtaining the above mentioned material properties. The material selection wizard interface may comprise one or more drop down or selection menus for obtaining the above mentioned material properties. The estimation engine 102 may comprise a material selection module (not depicted) that receives input via the material selection wizard interface, processes the input, and outputs materials, via the material selection wizard interface, that satisfy the selected or identified material properties input via the material selection wizard interface. The output may comprise a list of at least one material that satisfies the input material properties. The output may comprise an indication that no suitable material is available that meets the input material property criteria. The output list of materials may comprise a corresponding price for each material. The output list of materials may be automatically sorted and displayed in ascending or descending order by cost.

User configuration module 205 comprises user profile settings such as user specific custom configurations, particular computation and/or display preferences, preloaded user/customer specific materials, parts, etc. In addition, user configuration module 205 may allow a user to save past analysis configurations/inputs to be re-loaded or imported for subsequent review and analysis.

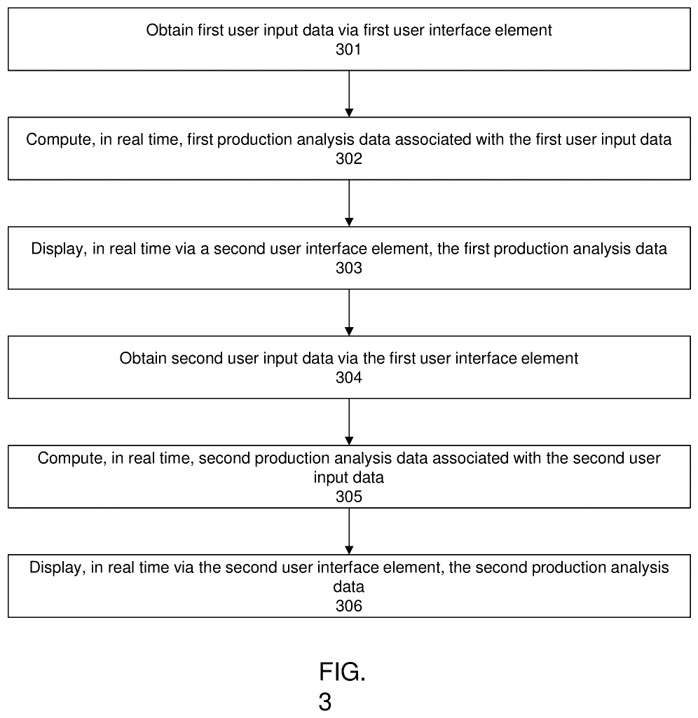

FIGS. 2B-2C illustrate exemplary user interfaces that may be generated and used in association with exemplary embodiments of the invention. The user interfaces comprise a first user interface element 210 which generally receives user input data and second user interface element 220 which generally displays output such as production analysis data computed using the user input data. FIG. 2B depicts an exemplary interface where part characteristics are manually entered. FIG. 2C depicts an exemplary interface where part characteristics are automatically determined from an uploaded part file (e.g. a computer aided design file) where a 3D rendering of the part is shown as part of the second user interface element 210. FIG. 3 below describes in detail the various user input data and output data (or production analysis data) associated with these different user interface elements.

Referring to FIG. 2B, it illustrates GUI elements 211, 212, 213, 214, 215, 216, 217, and 218. Each GUI element is described below. Variations to these elements that would be used or understood by a person of ordinary skill in the art are considered to be within the scope of this invention, including combining and/or separating the display of the described GUI elements.

Element 211 part production info is chronologically the 1st user input element that will help calculate your part cost. Quantity is also referred to Estimated Annual Usage. The lifetime element is to help the interface understand the return on investment. For example, if you have a model year change every 5 years, you will know you wont be using the mold investment for any longer period of time, therefore the interface will determine a lower cavity option with less capital costs. The third user interface input is number of cavities. Here is where you can change the number of cavities around to see the difference in part cost and tooling cost. Note that other user elements are dependent on some of these inputs. FIG. 215 will automatically show what number of cavities is optimal in respect to return on initial investment.

Element 212 part geometry info, is another important element relative to size. This can be a user input element or it can be calculated automatically by reading the 3D file that is inserted in the viewer. In this case the part length, width and depth are displayed to help the user understand rough overall box dimensions of the part. This can be displayed in inches or mm. This is also used to determine the cavitation layout size and size of the mold. The second part geometry input is volume. The volume of the part is calculated in cubic inches or cubic millimeters. Again, this information can be manually keyed in or it can be automatically populated off the part file. Model Volume is critical to understand how much plastic in weight is needed for a project. The volume of the part uses the specific gravity of the material selection to understand part weight and overall plastic demand. The final user input element can be manually entered or can automatically be calculated off the uploaded part file is the projected area of the part. Because clamping force calculations are based on profile size shown in both square inches or millimeter squared. This information is fed with material information to understand the minimum clamping force needed to produce the part with respect to the number of cavities.

Element 213 part composition info, is another input element where the user can select important features of the element. Material is referred to as the plastic type and cost. There are 2 possible selection groups in element 213. House material is a updated version of general polymers and prices that the user can consider when toggling through different materials to see the impact on price. The Customer Specific Material dropdown list is a custom populated list of materials that a certain user has populated based on their own usage. This could be a an approved material that the user commonly uses for their business. After the material database is populated with custom materials. The user specific login generates the list specific to that user. This way this information remains confidential to the user using it. The third input element in 213 is a list of additional part options. It includes adding specific colors to the part, adding special additives to the part. The additives and colors have a price associated and will help us understand the calculation as close to production as possible. Note that another part option is Texture. The user can select a specific texture on the part. This will help maintain all the part information details. Color and texture features can be instantly displayed on the 3D model viewer but are not necessary for the computation.

Element 214 part cost and tooling cost element are outputs. They are displayed top center to help the user see what changes with each change to the inputs. Quantity, lifetime, cavitation, volume, length, width, depth, volume, profile area, material selection are all used to calculate part cost and tool cost. Please note an interactive graph shows how the part cost can change based on the number of cavitation. Also, the optimal is highlighted so the user knows the best financial position. It is all orchestrated to give the user a fast effective way on understanding the information.

Element 215 Lifetime part cost Analysis is an output. This box lists all cavity options and where the best financial option is available. Note: 4 cavity is highlighted with a star. The higher the number of cavities per mold the more the mold will cost and the more demand on a larger more expensive press will be needed. But if the production rate, (how many parts per hour) justifies the increase in cavitation then it is to an advantage to add cavities. If the user understands the price difference between number of cavities and expected output. They will be more inclined to align the cavitation and initial investment with the optimal range.

Element 215 Lifetime part cost Analysis is an output. This box lists all cavity options and where the best financial option is available. Note: 4 cavity is highlighted with a star. The higher the number of cavities per mold the more the mold will cost and the more demand on a larger more expensive press will be needed. But if the production rate, (how many parts per hour) justifies the increase in cavitation then it is to an advantage to add cavities. If the user understands the price difference between number of cavities and expected output. They will be more inclined to align the cavitation and initial investment with the optimal range.

Element 216 Payback period projections is an output. This shows the financial payback on increasing cavities and initial investment over time.

Element 217 is an output showcasing some of the fine details in the overall analysis. Lead time, delivery date mold length width and weight. Annual part cost and how much of that cost is made up of materials, and packaging. The part weight is displayed and is a function of the material choice based on specific gravity of the material. The Labor portion of the output details the cycle time of one molding cycle based on maximum wall thickness of the part. The minimum press size is calculated by understanding the mold size and tonnage requirement based on the cross section profile area and the material selection. The press rate is figured based on national average press rate data that is populated every year.

Element 218 is an output pie chart showing multiple cavitation scenarios of labor vs. materials. The user is interested in reducing labor and thus can reflect on these elements.

Referring now to FIG. 2C, element 219 is the model viewer. When your file is uploaded in the display system it automatically populates many parameters including but not limited to Volume, Length, width, depth, maximum wall thickness, and projected profile area calculations. It also displays the part in 3D with full rotation and zoom functionality. If a user selects a certain material color the color changes on the part viewer, if they select a custom texture the texture will appear on the model.

Note that when the user is trained on how to use this display system they will have ability to quickly understand many of the confusing factors needed to develop a price effective injection molded part.

FIG. 3 illustrates an exemplary process for providing real-time, interactive custom part production analysis according to one embodiment of the invention. The process comprises obtaining first user input data via a first user interface element 301, computing, in real-time, first production analysis data associated with the first user input data 302, displaying, in real-time via a second user interface element, the first production analysis data 303, obtaining second user input data via the first user interface element 304, computing, in real-time, second production analysis data associated with the second user input data 305, and displaying, in real-time via the second user interface element, the second production analysis data 306.

At step 301, the process comprises obtaining, via a first user interface element, first user input data associated with a custom part to be made via injection molding. The first user input data comprises at least one of part dimensions such as length, width, and depth, part volume, maximum wall thickness, part profile area, annual quantity of parts to be produced, expected part lifetime, anticipated number of cavities for the mold, the material the part is to be made from, and any additional part options such as color, texture and additives. The first user interface element comprises at least one of a text entry field(s), a list(s) of selectable items such as a drop down menu(s), a drag and drop interface component, and a clickable interface component to initiate a file upload. Any of these features may be combined into an interface component. For example, a text entry field may also comprise a drop down menu and/or the ability to drag and drop a part file. In one aspect, the first user interface is configured such that it can receive a part file such as a computer aided design (CAD) file or receive part information via text entry such that when a part file is not available to be imported, part information may be obtained via manual entry. Furthermore, this configuration allows for importing part information from a part file to initiate production analysis and then allow for changing and updating part design information and see the effects of those changes in real-time or near real-time without requiring a user to create a new part file to be imported.

In one aspect, the first user input data comprises part dimension(s) entered via text entry field(s). In one aspect, the part dimension(s) are automatically determined from an imported part file received via the drag and drop interface component. In one aspect the list(s) or drop down menu(s) comprise at least one of a list of materials and associated pricing information, such as price by weight, for common injection molding materials, manufacturer specific materials, part/product specific materials, and custom materials. In one aspect, the list of materials is predefined, such as stored in a database and pulled from the database in order to populate the list on the first user interface element. In one aspect, the list of materials may be setup through a user configuration interface and process in order to generate lists of custom or user specific materials. In one aspect, the list of materials available for selection may be established by a user who enters or imports details associated with their specified materials. In one aspect, the list of materials is established and maintained by an administrator who controls and updates what is present in the list of materials and what materials are available to each user or universally available to all users, such as by updating a database of materials.

At step 302, the process comprises computing, in real-time, first production analysis data associated with the first user input data. Such production analysis computations may be performed by hardware and/or software such as a production analysis module 203 as described above. In one aspect the production analysis data is an estimate based on historical data such as national average production costs which are published periodically (e.g. annually, quarterly, etc.) or otherwise obtained for computation purposes. Alternatively, the production analysis data may be an estimate based on production costs associated with a specific injection molder. The production analysis data comprises at least one of tooling data, annual part cost data, and lifetime part cost data computed from the first user input data using injection molding manufacturing data.

Tooling data comprises at least one of tooling cost, lead time, estimated delivery date, mold length, mold width and mold size. Annual part cost data comprises a breakdown of material cost data and labor cost data. Material cost data comprises at least one of part weight, weight of material needed, material cost, and packaging cost. Labor cost data comprises at least one of cycle time, run time, press rate, minimum press weight requirement, press cost, and manual labor cost (which may be defined such as 1 whole operator, ½ operator, ¼ operator as an operator could operate multiple molding presses at one time). Lifetime part cost analysis comprises data associated with cost projections over time, a breakdown of cost savings or additional expenses associated with a plurality of different injection molding cavity options (e.g. 1, 2, 3, 4, 6, 8, etc. cavities), and a breakdown of the material and labor costs associated with at least one of the cavity options. The lifetime part cost analysis data may be displayed in the form of a graphical display such as bar and/or line graphs and pie charts any of which may also include alphabetic and/or numeric text data. In one aspect, the lifetime part cost analysis provides an indication of the most cost effective number of cavities to use in the molding process as determined based on user input data.

Computing production analysis data comprises simultaneous consideration of multiple factors, such as via a weighting algorithm, to compute the estimated production aspects. For example, increasing cavitation increases tooling costs, but at the same time reduces cost per part since energy, machine rate and labor rate are reduced since more parts are produced per cycle. For example, considering a scenario of two cavities with a cycle time of 60 seconds, two parts are made every 60 seconds, while a scenario of four cavities could produce four parts every 60 seconds, but would require a larger press size because the mold will require a larger mold press. Thus, increasing cavities is associated with more expensive press rate but at the same time increases part production per unit of time. The weighting algorithm considers this inverse relationships between cavitation and the energy, machine rate and labor rate in determining both tooling and part costs. As an additional consideration, user input associated with projected annual part production and part production lifetime may be factored into the weighting algorithm to determine a proper cavitation configuration which evaluates upfront costs versus product lifetime cost reduction and annual cost per part savings. For example, if it is projected for a given part that 25,000 units will be needed annually and the part has a lifetime production expectancy of five years, then a two cavity mold may provide the best balance of upfront costs versus lifetime production costs. However, if the same part is projected to need 75,000 units annually for the same 5 year lifetime production expectancy, then a four, six, or eighth cavity mold may be the more cost effective option for the lifetime of that part. In this scenario, even though greater cavitation may require increased upfront tooling costs and increased machine costs due to requiring higher tonnage presses, the cost per part and lifetime part costs are reduced because higher cavitation may result in less total machine time, labor time, and energy. The weighting algorithm accounts for the projected annual part production and part lifetime expectancy in computing the production analysis data. Another important consideration in the weighting algorithm is the specific gravity of the selected or identified material since the specific gravity will affect manufacturing costs due to its effects on at least press requirements and cycle time (which is made up of fill time, packing time, cooling time, and mold open time). The weighting algorithm accounts for this by determining appropriate manufacturing costs to be factored into the algorithm based on the chosen material.

At step 303, the process comprises displaying, in real-time via a second user interface element, the first production analysis data. Each of the production analysis data items mentioned above may be displayed. In one aspect, the displaying comprises simultaneously displaying the first production analysis data across a plurality of different user devices so that multiple users are able to see the same production analysis data in real time. For example, a plurality of users collaborating on a project are able to view the same production analysis data in real-time while collaborating on a project from different user devices and/or different locations. In one aspect, displaying also comprises displaying the first user input data in the first user interface element so that users are able to simultaneously view the input data that corresponds to the first production analysis data being displayed.

At step 304, the process comprises obtaining second user input data via the first user interface element. In one aspect, the second user input data may be obtained from the same user and same user device as the first user input data. In one aspect, the second user input data may be obtained from a different user using a different user device such as in circumstances where a plurality of users are collaborating remotely on a project with both being able to interact with and see the same user interface on their respective user devices. Second user input data may comprise a change to at least one of the above listed first user input items. For example, a user may change a single variable such as material or number of cavities to use in the anticipated molding process in order to evaluate the effects of such a change on the production analysis data. These are merely exemplary changes and any one or more of the above listed user input items may be changed as part of the obtaining second user input data.

At step 305, the process comprises computing, in real-time, second production analysis data associated with the second user input data. The computation is the same discussed above in step 302 however using the new second user input data in order to compute a second set of production analysis data.

At step 306, the process comprises displaying, in real-time via the second user interface element, the second production analysis data. This displaying comprises the same displaying as discussed above with respect to step 303 however displays the updated second production analysis data in response to the second user input data being obtained.

The above process may be implemented such that any number of iterations of obtaining input data, real-time computing of production analysis data, and real-time display of corresponding production analysis data are performed. In this way, users can see in real-time the effects of changing one or more input variables on the production analysis data so that design decisions can be made in real-time without the typical delays associated with current approaches which generally require waiting for quote information from injection molding companies. Although not depicted in the process diagram, for any iteration of the process, a user may submit the input part information for a formal quote via the first user interface element such as via clicking a button that is part of the first user interface element to automatically send the necessary part information to an appropriate injection molder quoting entity. In one aspect submitting part information for a formal quote comprises generation and transmission of an automated message (e.g. email confirmation) which may comprise a confirmation of the details of the submitted part information and an estimated timeframe for when the formal quote will be available. The automated message may be generated and transmitted by an estimation engine 102 as discussed above or by another component or unit configured to handle aspects related to the formal quoting process.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, components, elements or the like may be and/or comprise hardware and/or software as described herein.

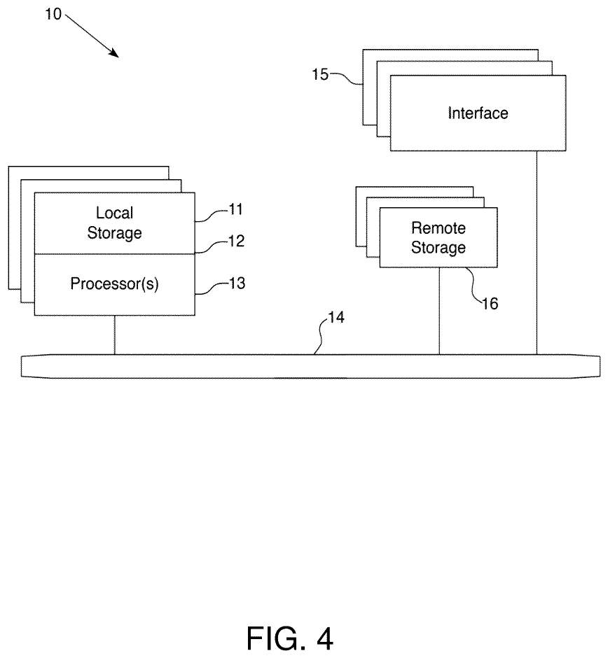

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

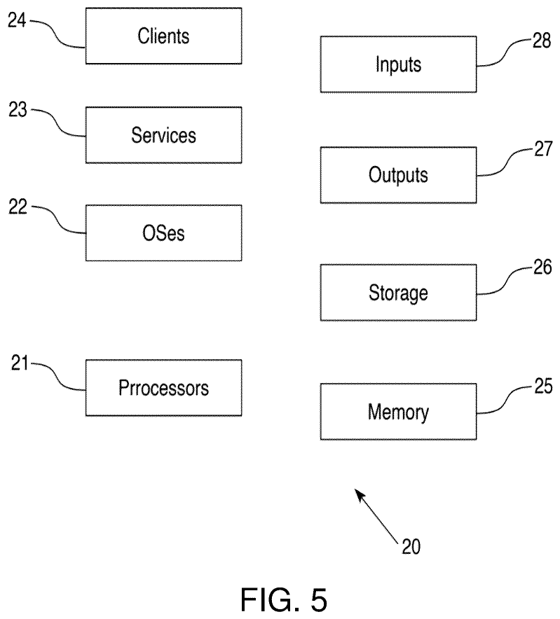

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

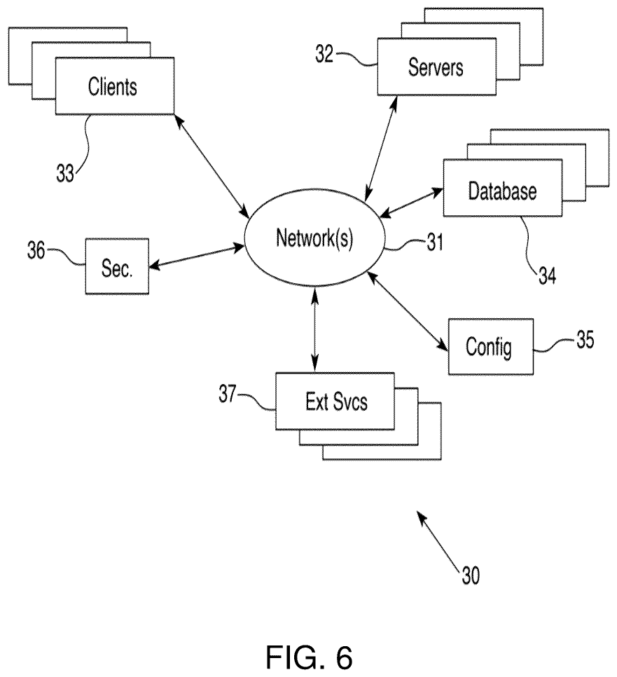

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, a serverless database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

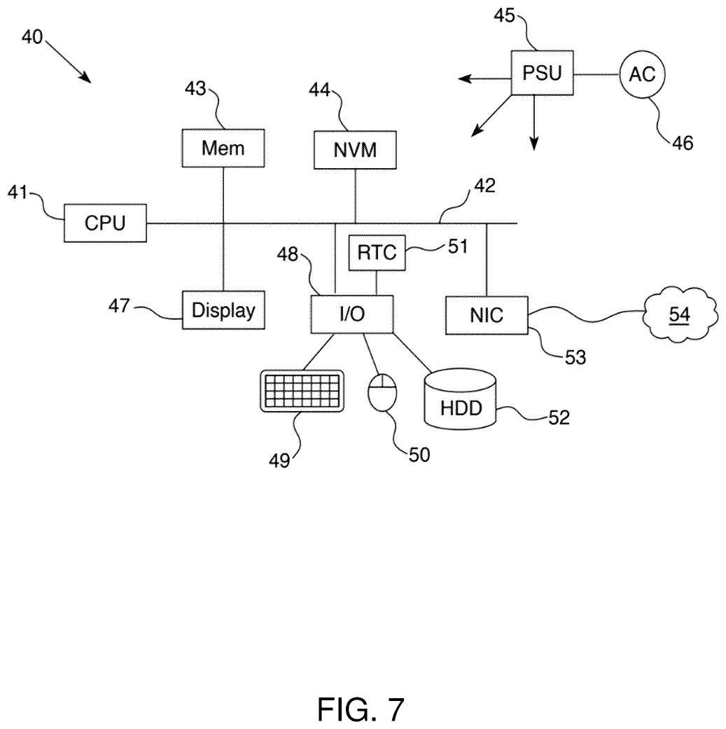

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein.

Various apparent modifications, changes and variations may be made in the arrangement, operation and details of the method and apparatus disclosed herein without departing from the spirit and scope defined in the appended claims.

What is claimed is:

1. A graphical user interface for providing real-time feedback for injection molded part planning and return on investment optimization, the graphical user interface comprising:
a first user interface element for obtaining part production information;
a second user interface element for obtaining part geometry information;
a third user interface element for obtaining part composition information;
a fourth user interface element displaying at least one of a cost per part estimate and a tooling cost estimate, the cost per part estimate and tooling cost estimate determined based on the information obtained from the first, second and third user interface elements;
at least one of a fifth user interface element, sixth user interface element, and seventh user interface element;
the fifth user interface element displaying lifetime part cost analysis information;
the sixth user interface element displaying at least one of a projected cost as a function of elapsed time for each of a plurality of different cavity options and a projected cost savings as a function of elapsed time for a plurality of different cavity options; and
the seventh user interface element displaying a breakdown of factors associated with at least one of estimated tooling costs, estimated material costs, estimated labor costs, and estimated annual part cost;
wherein obtaining new information via at least one of the first, second, and third user interface elements, results in displaying, in real-time, up to date estimated part cost information in at least one of the fourth, fifth, sixth and seventh user interface elements.

2. The graphical user interface according to claim 1, wherein the part production information comprises at least one of a part quantity, a part production lifetime, and a projected number of cavities to be used for part production.

3. The graphical user interface according to claim 1, wherein the part geometry information comprises at least one of part dimensions, part volume, part wall thickness, and part profile area.

4. The graphical user interface according to claim 1, wherein the part geometry information is automatically extracted from a part file uploaded through the second user interface element.

5. The graphical user interface according to claim 1, wherein part composition information comprises at least one of part material, part coating, material color, part texture, and material additives.

6. The graphical user interface according to claim 5, wherein the part material comprises at least one of a house material, a standard material and a custom material.

7. The graphical user interface according to claim 5, wherein the third user interface element displays at least one of part material cost, part coating cost, material color cost, part texture cost, and material additive cost.

8. The graphical user interface according to claim 1, wherein the lifetime part cost analysis information comprises at least one of a recommended number of cavities and a plurality of projected costs, each of the plurality of projected costs associated with a different number of cavities.

9. The graphical user interface according to claim 8, wherein the recommended number of cavities is associated with a projected minimum lifetime cost.

10. The graphical user interface according to claim 1, wherein the tooling factors comprise at least one of lead time, mold length, mold width, mold size, and estimated delivery date.

11. The graphical user interface according to claim 1, wherein the material factors comprise part mass or weight, projected material mass or weight needed, projected material cost, and projected packaging cost.

12. The graphical user interface according to claim 11, wherein the material factors comprise at least one material factor displayed as a per year value.

13. The graphical user interface according to claim 1, wherein the labor factors comprise at least one of cycle time, projected press run time, minimum press force requirement, projected press cost rate, projected total press cost, and projected press labor cost.

14. The graphical user interface according to claim 13, wherein the labor factors comprise at least one labor factor displayed as a per year value.

15. The graphical user interface according to claim 1, wherein the estimated annual part cost comprises a sum of material and labor costs relative to a projected years of part production.

16. The graphical user interface according to claim 1, further comprising an eighth user interface element displaying at least one of tooling costs relative to total part costs, and the sum of material and labor costs relative to total part costs.

17. The graphical user interface according to claim 16, wherein the display of relative costs comprises at least one of a pie chart or bar chart.

18. The graphical user interface according to claim 16, wherein the display of relative costs comprises a display of relative costs for a plurality of different cavity options.
